(19) United States
(12) Patent Application Publication
(10) Pub. No.: US 2008/0074574 A1
(43) Pub. Date: Mar. 27, 2008

(54) BACKGROUND LIGHT MODULE WITH OVAL LENSES

(75) Inventor: Huan-Chang Huang, Taoyuan County (TW)

Correspondence Address: PAI PATENT & TRADEMARK LAW FIRM, 1001 FOURTH AVENUE, SUITE 3200, SEATTLE, WA, 98154, US

(73) Assignee: TOPSON OPTOELECTRONICS SEMI-CONDUCTOR CO., LTD., Taoyuan County (TW)

(21) Appl. No.: 11/530,458

(22) Filed: Sep. 9, 2006

(51) Int. Cl. G02F 1/1335

(52) U.S. Cl. 349/57

(57) ABSTRACT

The background light module for LCD utilizes LED as its light source, a single light generating LED die is grouped in an arcuately shaped oval lens to form an LED light source unit, and several LED light source units constructed as such are combined to form a background light module on a support arm to illuminate the LCD so as to create a brilliant and comfortable lighting effect.

### BACKGROUND OF THE INVENTION

1. Field of the Invention

The present invention relates to a background light module with oval lenses and more particularly to a background light module in which the LED (light emission diode) is used as the light source, a single LED die is grouped in an arcuately shaped oval lens to form an LED light source unit, and a plurality of LED light source units constructed as such are combined to form a background light module to illuminate an LCD so as to provide a brilliant and comfortable lighting effect.

2. Description of the Prior Art

Presently the cold cathode fluorescent lamp (CCFL) is mostly used as an LCD background light source. The CCFL is equipped behind an LCD to irradiate light to the LCD after the light is regulated by a light conducting plate, a diffuser, and a refractor for the LCD to display a picture. It is a trend that the LCD display board becomes larger and larger to meet the user's needs, the capacity of the CCFL and its driving circuit is also enlarged. To meet the requirements of a large sized LCD board, a plurality of CCFLs are connected in series and in parallel to form a corresponding background light source to output a sufficient amount of light to illuminate the LCD board.

However, the background light source constructed as such has several inherent shortcomings, namely:

1. Poor luminance of CCFL can not provide the LCD board with sufficient light even when a plurality of lamps are connected either in series or in parallel.

2. Relatively short lifespan (4000˜6000 hrs.), quick fading of the luminous flux output and difficult replacement of CCFL make it impracticable for use as a background light source for LCD.

3. With 4800° k color temperature only attaining 80% color rendering index of NTSC standard reveals inadequate saturation of a perceived object color, especially in the range of red spectrum that is unable to satisfy high level demand for specially designated photometrical hue.

4. Comparatively high power consumption and environmentally harmful content of mercury will make CCFL not allowable for use as background light source of LCD starting Jul. 1, 2006 under the Kyoto Protocol.

For these reasons, another alternative background light source is urgently needed. The present trend for alternative LCD background light sources is directed to high intensity white color LEDs, whereas the application of LEDs for a small sized LCD, such as cell phones, and PDA, has lasted for a certain period of time. Following the technological improvements, the brightness of the LED has been marvelously improved, and along with other merits such as compactness, light weight, toughness and long life, the LED is now being applied as the background light source of large sized LCDs.

The common practice in installation of LEDs as the LCD background light source is to dispose different numbers of LEDs at one or both sides of the LCD such that when the power supply is turned on, the light from the LEDs is delivered to the LCD so that a picture appears on the LCD. It is to be understood that the light emitted from the LEDs is not always uniformly diffused but concentrated at a small area, creating a non-uniform lighting effect. Such a flaw might be overcome by intensively disposing a number of LEDs so as to overlap the lighting area of adjacent LEDs, thereby reducing the dark areas. Doing so will increase the engineering cost as well as the consumption of power with little improvement of lighting effect, while the problematic non-uniformity of lighting on the LCD remains unresolved.

The applicant believes a thorough solution to the above problem is to vary aspect in disposing the LEDs, and after a long term study with experimentation, the applicant has succeeded in coming up with the present invention.

### SUMMARY OF THE INVENTION

Accordingly, the main object of the present invention is to provide a background light module with oval lenses to output uniformly diffused light to illuminate an LCD.

Another object of the present invention is to use high intensity white color LEDs as background light source so as to enable the LCD to display a qualified brilliant picture with a prolonged lifespan.

To achieve the above objects, the background light module of the present invention is constructed of a plurality of LED light source units together with several sheet conductors disposed on a support arm and connected to a driving circuit. The LED dies are installed on the support arm and electrically connected to the adjacent sheet conductors at two sides with wires. Then each of the LED light source units on the support arm is enclosed with epoxy resin to form an oval lens package. The arcuate shape of the oval lens makes the light from the LED light source units to uniformly irradiate in all directions. As a result, the light output from the LED dies is radiated on the LCD through the arcuately shaped oval lenses so that a uniformly diffused brilliant and comfortable lighting surface is created on the LCD.

### BRIEF DESCRIPTION OF THE DRAWINGS

The drawings disclose an illustrative embodiment of the present invention which serves to exemplify the various advantages and objects thereof.

FIG. 1 is a perspective view of an LED light source unit according to the present invention;

FIG. 2 is a schematic view showing a plurality of LED light source units disposed on the support arm according to the present invention;

FIG. 3 is a top view of FIG. 2; and

FIG. 4 is a front view of FIG. 2.

### DETAILED DESCRIPTION OF THE PREFERRED EMBODIMENT

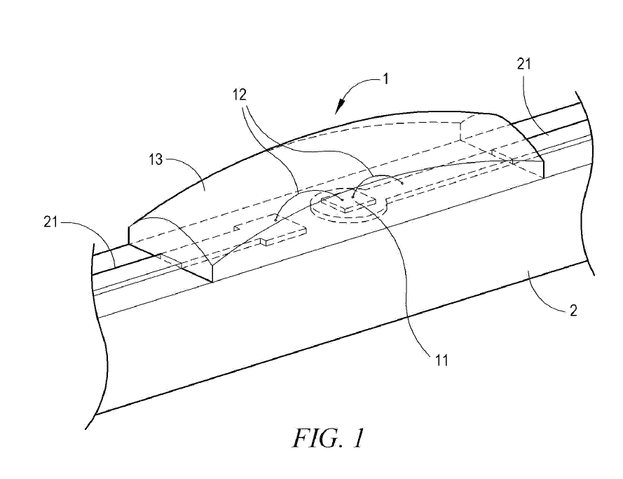

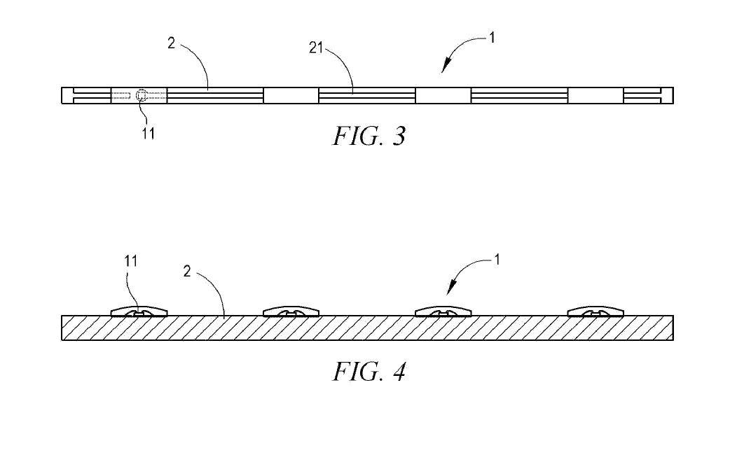

Referring to FIG. 1 through FIG. 4, the present invention provides a background light module with oval lenses comprising a support arm 2 on which several LED light source units 1 are installed. Light output from each of the LED light source units 1 is radiated on an LCD (not shown). The light emitted from individual LED light source units 1 can be partially overlapped so as to assure effective distribution of light on the LCD.

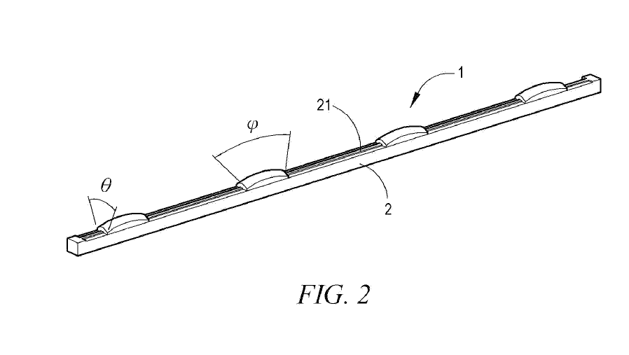

Several sheet conductors 21 are provided on the support arm 2 for connecting with a driving circuit (not shown) to control the ON/OFF of the LED light source units 1. The light generating dies 11 of the LED light source units 1 are installed on the support arm 2 with connecting wires 12 extended to adjacent sheet conductors 21 at its two sides. After finishing installation and electrical connection, each of the LED light source units 1 is enclosed with epoxy resin to form a package of oval lens 13. With this structure, the light emitted from the light generating dies 11 is conducted to illuminate the LCD via the oval lens 13. The oval lens 13 has an arcuate shape as shown in FIG. 2 with a center angle of sector 0=45˜60° when cut transversely, and Φ=120° when cut longitudinally. With this shape, tests prove that the light from the LED light source units 1 would surely distribute uniformly on the surface of the LCD without being concentrated on a particular area so that the overall surface of the LCD can be sufficiently illuminated with an even brilliancy.

Incidentally, the material of the oval lens 13 is not limited to epoxy resin; any high light permeable substance may be allowed as an alternative selection. The LED used in the LED light source unit 1 in the present invention is a high intensity white color LED so as to assure higher brilliancy and better quality of pictures on the LCD.

Many changes and modifications in the above described embodiment can, of course, be carried out without departing from the scope thereof. Accordingly, to promote the progress of science and the useful arts, the invention is disclosed and is intended to be limited only by the scope of the appended claims.

What is claimed is:

1. A background light module comprising a plurality of LED light source units 1, each comprising an LED die enclosed with an arcuately shaped oval lens 13 so as to uniformly illuminate a surface of an LCD with light output of said LED light source units 1.

2. The background light module of claim 1, wherein said LED light source units 1 are installed on a support arm 2 with sheet conductors 21 provided at two sides of each LED light source unit 1 for said light generating die 11 of each LED light source unit 1 to be connected to a driving circuit by extending conductor wires from said light generating die 11 to the sheet conductors 21 at the two sides of each LED light source unit 1.

3. The background light module of claim 1, wherein said oval lens 13 is made of a high light permeable substance.
